(19) United States
(12) Patent Application Publication
(10) Pub. No.: US 2024/0413306 A1
(43) Pub. Date: Dec. 12, 2024

(54) ELECTRICITY STORAGE DEVICE

(71) Applicant: Prime Planet Energy & Solutions, Inc., Tokyo (JP)

(72) Inventor: Surim KANG, Kobe-shi (JP)

(21) Appl. No.: 18/675,168

(22) Filed: May 28, 2024

(30) Foreign Application Priority Data
Jun. 9, 2023 (JP) 2023-095371

(51) Int. Cl. H01M 4/36; H01M 4/02; H01M 4/38

(52) U.S. Cl. CPC H01M 4/364; H01M 4/386; H01M 2004/027

(57) ABSTRACT

Provided is a technology that realizes a more preferable specific surface area in a negative electrode active material layer including silicon. An electricity storage device disclosed herein includes a negative electrode active material layer including a negative electrode active material. The negative electrode active material includes first particles including silicon and second particles that include silicon and are different from the first particles. An average circularity CR1 of the first particles is 0.5 or more and 0.9 or less. An average circularity CR2 of the second particles is more than 0.9. A ratio (D1/D2) between an average particle diameter D1 of the first particles and an average particle diameter D2 of the second particles is 0.1 or more and less than 1.

### CROSS REFERENCE OF RELATED APPLICATION

The present application claims the priority based on Japanese Patent Application No. 2023-095371 filed on Jun. 9, 2023, the entire contents of which are incorporated in the present specification by reference.

### BACKGROUND OF THE DISCLOSURE

### 1. Field

The present disclosure relates to an electricity storage device.

### 2. Background

A negative electrode active material disclosed in Japanese Laid-open Patent Publication No. 2017-92009 includes negative electrode active material particles containing silicon compound particles including a silicon compound (SiOₓ: 0.5≤x≤1.6). The silicon compound particles contain at least one of Li₂SiO₃ and Li₄SiO₄. The negative electrode active material particles have a loose bulk density BD of 0.5 g/cm³ or more and 0.9 g/cm³ or less, has a tap bulk density TD of 0.7 g/cm³ or more and 1.2 g/cm³ or less and, for the negative electrode active material particles, a compaction degree defined by (TD-BD)/TD is 25% or less. In Japanese Laid-open Patent Publication No. 2017-92009, it is described that, as for the negative electrode active material particles including silicon compound particles, the negative electrode active material particles are particles obtained by modifying a SiO₂ component portion in the silicon compound that is destabilized when lithium is inserted and desorbed during charging and discharging of a battery to lithium silicate in advance, and therefore, an irreversible capacity generated during charging can be reduced. In Japanese Laid-open Patent Publication No. 2017-92009, it is described that a cycle characteristic of a battery or the like is increased by achieving predetermined loose bulk density, tap density, and compaction degree of the negative electrode active material particles. Furthermore, it is described that, using the negative electrode active material particles described above, an electrode filling property can be increased, and accordingly, a cycle characteristic of a secondary battery can be increased.

A negative electrode active material disclosed in Japanese Laid-open Patent Publication No. 2019-175851 includes composite particles in which at least portions of surfaces of silicon oxide particles and graphite particles are coated with a low crystalline carbon material having a lower crystallinity than that of the graphite particles. The composite particles contain 50 to 500 parts by mass of silicon oxide particles and 200 to 2000 parts by mass of graphite particles against 100 parts by mass of the low crystalline carbon material. For the composite particles, on a differential curve of a thermogravimetric curve obtained by a thermogravimetric analysis under oxygen containing atmosphere, two peaks of weight reduction due to heating are observed and one of the two peaks that is observed at a lower temperature side is observed in a temperature range of 500° C. to 600° C. According to Japanese Laid-open Patent Publication No. 2019-175851, a negative electrode active material for a lithium-ion secondary battery that has a large initial discharge capacity and enables manufacturing of a lithium-ion secondary battery having an excellent charging and discharging cycle characteristic can be provided.

### SUMMARY

An inventor of the present application desires to achieve a more preferable specific surface area in a negative electrode active material layer including silicon.

An electricity storage device disclosed herein includes a negative electrode active material layer including a negative electrode active material. The negative electrode active material includes first particles and second particles that include silicon. The second particles are different particles from the first particles. An average circularity CR1 of the first particles is 0.5 or more and 0.9 or less. An average circularity CR2 of the second particles is more than 0.9. A ratio (D2/D1) between an average particle diameter D1 of the first particles and an average particle diameter D2 of the second particles is 0.1 or more and less than 1. According to the configuration described above, a more preferable specific surface area can be achieved in the negative electrode active material layer including silicon in the electricity storage device.

### BRIEF DESCRIPTION OF THE DRAWINGS

FIG. 1 is a schematic cross-sectional view of an electricity storage device.

FIG. 2 is a schematic view of an electrode body.

FIG. 3 is a schematic cross-sectional view of a negative electrode sheet.

### DETAILED DESCRIPTION OF THE PREFERRED EMBODIMENTS

A preferred embodiment of a technology disclosed herein will be described below. The preferred embodiment described herein is not intended to be particularly limiting the technology disclosed herein. The technology disclosed herein is not limited to the preferred embodiment described herein, unless specifically stated otherwise. The accompanying drawings are schematic and do not necessarily reflect actual members or portions. Members/portions that have the same effect will be denoted by the same sign as appropriate and the overlapping description will be omitted as appropriate. The notation “A to B” that indicates a numerical range means “A or more and B or less” and also encompasses “more than A and less than B,” unless specifically stated otherwise.

As used in this specification, the term “electricity storage device” refers to devices in which charge carriers move between a pair of electrodes (a positive electrode and a negative electrode) via an electrolyte and thus a charging and discharging reaction occurs. Such electricity storage devices include secondary batteries, such as a lithium-ion secondary battery, a nickel hydrogen battery, a nickel cadmium battery, or the like and capacitors, such as a lithium-ion capacitor, an electric double-layered capacitor, or the like. A preferred embodiment in which, as an example of the electricity storage devices described above, a lithium-ion secondary battery is a target will be described below.

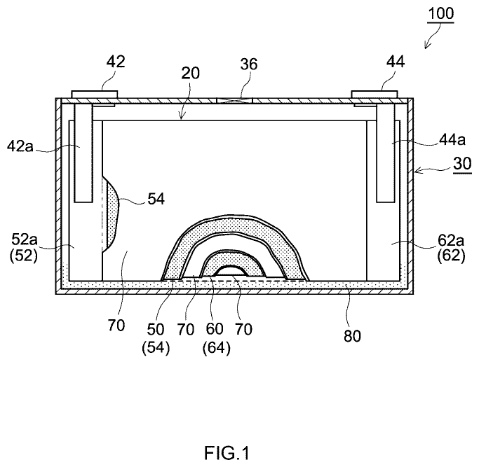

FIG. 1 is a schematic cross-sectional view of an electricity storage device 100. FIG. 1 is a schematic cross-sectional view along a broad width surface having a largest width in the electricity storage device 100. As illustrated in FIG. 1, the electricity storage device 100 includes an electrode body 20, a case 30, and a nonaqueous electrolyte solution 80.

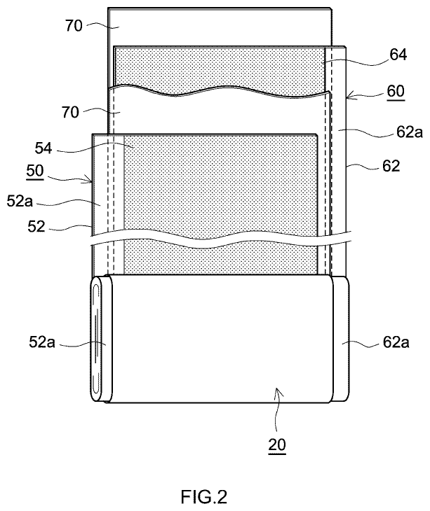

FIG. 2 is a schematic view of the electrode body 20. As illustrated in FIG. 1 and FIG. 2, the electrode body 20 is a wound electrode body formed by stacking a long sheet-like positive electrode sheet 50 and a long sheet-like negative electrode sheet 60 with a long sheet-like separator 70 interposed therebetween and winding a stacked body in a sheet longitudinal direction (which will be hereinafter also referred to simply as a “longitudinal direction”). In the electrode body 20, each of an exposed area 52a in the positive electrode sheet 50 and an exposed area 62a in the negative electrode sheet 60 protrudes outward from a corresponding one of both ends of the electrode body 20 in a lateral direction orthogonal to the longitudinal direction.

As illustrated in FIG. 1 and FIG. 2, the positive electrode sheet 50 includes a long sheet-like positive electrode current collecting foil 52 and a positive electrode active material layer 54. The positive electrode current collecting foil 52 is, for example, an aluminum foil. In this preferred embodiment, the positive electrode current collecting foil 52 includes an area in which the positive electrode active material layer 54 is provided and the exposed area 52a in which the positive electrode active material layer 54 is not provided and a surface of the positive electrode current collecting foil 52 is exposed. The positive electrode active material layer 54 is provided, for example, on one surface or both surfaces (both surfaces herein) of the positive electrode current collecting foil 52 to extend in the longitudinal direction and have a band-like shape. The positive electrode active material layer 54 is not provided in an end portion of the positive electrode current collecting foil 52 in the lateral direction (in FIG. 2, an end portion at left). The exposed area 52a is herein an area having a band-like shape in the end portion in the lateral direction (in FIG. 2, the end portion at left). As illustrated in FIG. 1, a current collecting plate 42a is attached to the exposed area 52a.

The positive electrode active material layer 54 includes, for example, a positive electrode active material. Examples of the positive electrode active material include, for example, a lithium-transition metal oxide, such as lithium nickel cobalt manganese composite oxide (NCM) (for example, LiNi_{1/3}Co_{1/3}Mn_{1/3}O₂), LiNO₂, LiCoO₂, LiFeO₂, LiMn₂O₄, LiNi_{0.5}Mn_{1.5}O₄, or the like, a lithium-transition metal phosphate compound, such as LiFePO₄ or the like, or the like. The positive electrode active material layer 54 may include, in addition to the positive electrode active material, a conductive material, a binder, or the like. Examples of the conductive material include, for example, carbon black, such as acetylene black (AB) or the like, and other carbon materials, such as graphite or the like. Examples of the binder include, for example, polyvinylidene fluoride (PVDF) or the like.

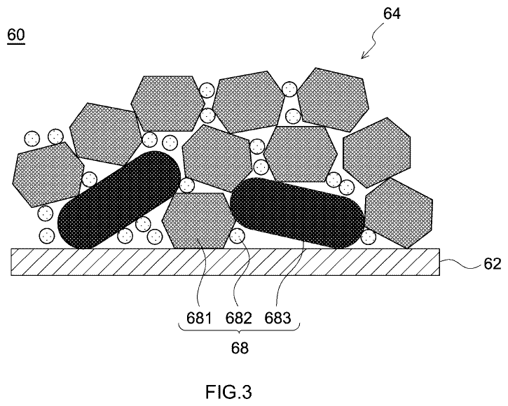

FIG. 3 is a schematic cross-sectional view of the negative electrode sheet 60. In FIG. 3, a cross-sectional structure of a negative electrode current collecting foil 62 and a negative electrode active material layer 64 in the negative electrode sheet 60 is partially enlarged and illustrated. As illustrated in FIG. 1 to FIG. 3, the negative electrode sheet 60 includes a long sheet-like negative electrode current collecting foil 62 and the negative electrode active material layer 64. The negative electrode current collecting foil 62 is, for example, a copper foil. In this preferred embodiment, the negative electrode current collecting foil 62 includes an area in which the negative electrode active material layer 64 is provided and the exposed area 62a in which the negative electrode active material layer 64 is not provided and a surface of the negative electrode active material layer 64 is exposed. The negative electrode active material layer 64 is provided, for example, on one surface or both surfaces (both surfaces herein) of the negative electrode current collecting foil 62 to extend in the longitudinal direction and have a band-like shape. The negative electrode active material layer 64 is not provided in an end portion of the negative electrode current collecting foil 62 in the lateral direction orthogonal to the longitudinal direction (in FIG. 2, an end portion at right). The exposed area 62a is herein an area having a band-like shape in the end portion in the lateral direction (in FIG. 2, the end portion at right). As illustrated in FIG. 1, a current collecting plate 44a is attached to the exposed area 62a.

Incidentally, for example, in order to increase capacity of an electricity storage device, a negative electrode active material including silicon is used in some cases. It was found from a study of the inventor of the present application that, when only a negative electrode active material having a high average circularity is used, a filling density of the negative electrode active material in a negative electrode active material layer can be increased, but there are not enough voids in the negative electrode active material, so that an internal stress tends to be increased. It was also found from the study of the inventor of the present application that, when only a negative electrode active material having a low average circularity is used, voids can be properly provided in the negative electrode active material layer, but because of stress of pressing the negative electrode active material layer in a manufacturing process, the negative electrode active material tends to crack. Cracks of the negative electrode active material can increase a specific surface area in the negative electrode active material layer and thus cause reduction in capacity of the electricity storage device. The inventor of the present application considered that, for example, by suppressing increase in the specific surface area before and after pressing in the manufacturing process, a more preferable specific surface area can be achieved in the negative electrode active material layer including silicon. The inventor of the present application considered that reduction in capacity of the electricity storage device can be suppressed accordingly and also a high-density negative electrode active material layer in which the internal stress caused by expansion and contraction is properly relaxed can be achieved. Note that “the negative electrode active material having a high average circularity” is herein a negative electrode active material having an average circularity that is more than 0.9. “A negative electrode active material having a low average circularity” is herein a negative electrode active material having an average circularity equal to or less than 0.9.

As illustrated in FIG. 3, the negative electrode active material layer 64 includes a negative electrode active material 68. The negative electrode active material 68 herein includes first particles 681 and second particles 682. The first particles 681 are particles including silicon. The second particles 682 are particles that include silicon and are different from the first particles 681. For example, the first particles 681 and the second particles 682 are different from each other with respect to average circularity and average particle diameter.

An average circularity CR1 of the first particles 681 is, for example, 0.5 to 0.9. From a viewpoint of increasing a density of the negative electrode active material layer 64, the average circularity CR1 is preferably 0.6 or more, is more preferably 0.7 or more, and is even more preferably 0.75 or more. From a viewpoint of providing proper voids in the negative electrode active material layer 64, the average circularity CR1 is preferably 0.85 or less and is more preferably 0.8 or less. An average circularity CR2 of the second particles 682 is, for example, more than 0.9. From a viewpoint of increasing the density of the negative electrode active material layer 64, the average circularity CR2 is preferably 0.91 or more, is more preferably 0.92 or more, and is even more preferably 0.93 or more. From a viewpoint of providing proper voids in the negative electrode active material layer 64, the average circularity CR2 is preferably less than 1, is preferably 0.98 or less, is more preferably 0.96 or less, and is even more preferably 0.95 or less.

In this specification, an “average circularity” of particles is an arithmetic average value of circularities of 1000 or more particles (for example, 3000 particles) extracted at random. As for the circularity herein, a particle image of each of particles are analyzed, and the circularity is calculated from a circumference (L) of each of the particles and a circumference (L0) of a circle having a same projection area as that of the particle using Expression A below.

$$Circularity = L 0 / L \qquad Expression A$$

As an image analyzer used for calculating the average circularity, an imaging type particle size distribution measuring device used for this kind of application can be used, but not limited to.

The second particles 682 are preferably particles having a smaller size than that of the first particles 681. Thus, relatively small second particles 682 enter voids between relatively large first particles 681, so that the density of the negative electrode active material layer 64 can be increased. From a viewpoint of achieving the effect described above, a ratio (D2/D1) between an average particle diameter D1 of the first particles 681 and an average particle diameter D2 of the second particles 682 may be 0.1 or more and less than 1, is preferably 0.8 or less, and is more preferably 0.6 or less. From a viewpoint of achieving an effect of suppressing reduction of a capacity retention rate of the electricity storage device 100, the ratio (D2/D1) is even more preferably 0.5 or less and is particularly preferably 0.4 or less. In order to prevent voids in the negative electrode active material layer 64 from being reduced too much by the second particles 682 that have entered voids between the first particles 681, the ratio (D2/D1) is preferably 0.15 or more and is more preferably 0.2 or more.

There is no particular limitation on the average particle diameter D1 and the average particle diameter D2 as long as an effect of the technology disclosed herein can be achieved. The average particle diameter D1 may be generally 3 μm to 25 μm. From a viewpoint of properly providing voids in the negative electrode active material layer 64, the average particle diameter D1 is preferably 5 μm or more, and is more preferably 7.5 μm or more, or is preferably 20 μm or less and is more preferably 15 μm or less. The average particle diameter D2 may be generally 0.3 μm to 10 μm. From a viewpoint of facilitating entrance of the second particles into voids between the first particles 681, the average particle diameter D2 is preferably 8 μm or less and is more preferably 6 μm or less. From a viewpoint of achieving a reduction suppression effect for the capacity retention rate, the average particle diameter D2 is even more preferably 5 μm or less and is particularly preferably 4 μm or less. In order to prevent voids in the negative electrode active material layer 64 from being reduced too much by the second particles 682 that have entered voids between the first particles 681, the average particle diameter D2 is preferably 0.5 μm or more and is more preferably 0.7 μm or more. In addition to the above-described effect, from a viewpoint of achieving an effect of suppressing reduction of the capacity retention rate, the average particle diameter D2 is even more preferably 1 μm or more and is particularly preferably 2 μm or more. Note that, in this specification, with regard to particles, the “average particle diameter” refers to a particle diameter (Dso particle diameter) equivalent to cumulative 50% from a microparticle side in a particle size distribution on a volume basis measured according to a particle size distribution measurement based on a laser diffraction and light scattering method.

In order to provide proper voids, the negative electrode active material layer 64 may include more first particles 681 than the second particles 682. There is no particular limitation on a ratio (mass ratio) (C2/C1) between a content C1 of the first particles 681 and a content C2 in the negative electrode active material 68 as long as the effect of the technology disclosed herein can be achieved. The ratio (C2/C1) may be generally 0.03 or more and less than 1. From a viewpoint of achieving the effect of the technology disclosed herein, the ratio (C2/C1) is preferably 0.05 or more, is more preferably 0.08 or more, and is even more preferably 0.1 or more. In addition to the effect described above, from a viewpoint of suppressing reduction of the capacity retention rate of the electricity storage device 100, the ratio (C2/C1) is preferably 0.8 or less, is more preferably 0.7 or less, is even more preferably 0.5 or less, and is particularly preferably 0.3 or less.

Both of the first particles 681 and the second particles 682 may be, for example, composite particles of silicon and carbon. Composite particles of silicon and carbon are, for example, particles that are formed by integration of silicon and carbon and serve like one particle. The composite particles of silicon and carbon will be hereinafter also referred to as “Si/C particles.” When the first particles 681 and the second particles 682 are Si/C particles, a degree of deformation of the first particles 681 and the second particles 682 due to a manufacturing process of the electricity storage device 100 and charging and discharging thereof can be reduced. Therefore, in the negative electrode active material layer 64, a preferable specific surface area can be easily achieved.

The Si/C particles include, for example, silicon on a surface of a carbon material and inside the carbon material. The carbon material may be, for example, a porous carbon material. The porous carbon material is herein a carbon material having fine pores. Fine pores of the porous carbon material can contribute to, for example, relaxing of expansion and contraction of silicon due to charging and discharging of the electricity storage device 100. Therefore, the internal stress of the negative electrode active material layer 64 can be reduced since the carbon material of the Si/C particles is the porous carbon material. Silicon may be carried by, for example, fine pores of the porous carbon material. By silicon being carried by the fine pores of the porous carbon material, for example, when silicon expands, the fine pores can absorb a portion of silicon that has expanded. Note that the porous carbon material is preferably fibrous or granular, but not particularly limited to.

The Si/C particles are manufactured, for example, by a method described below. However, a method for manufacturing Si/C particles is not limited to the method described below. The method for manufacturing Si/C particles includes, for example, a preparation step, a mixing step, and a heating step.

The preparation step is, for example, a step of preparing a composite (SiO—C composite) of the porous carbon material and SiO and a metal reducing agent as raw materials. As the metal reducing material, a metal reducing agent used for this kind of application is used without particular limitation. The metal reducing agent may be, for example, magnesium (Mg), aluminum (Al), or the like.

The mixing step is, for example, a step of mixing the raw materials prepared in the preparation step. By performing the mixing step, a mixture of the SiO—C composite and the metal reducing agent as the raw materials is obtained. Herein, the raw materials may be mixed using a known mixing tool, such as a mortar or the like.

The heating step is, for example, a step of heating the mixture obtained in the mixing step. A reducing reaction by the metal reducing agent can be caused by performing the heating step. Accordingly, for example, SiO of the SiO—C composite is reduced to Si and silicon (Si) is arranged in the fine pores of the porous carbon material. The heating step is preferably performed, for example, in a noble gas atmosphere, such as an argon atmosphere or the like, or in an inert atmosphere, such as a nitrogen atmosphere or the like. A temperature condition of heating in the heating step may be, for example, 200° C. to 500° C. A heating time may be, for example, 0.1 hours to 10 hours.

Note that, when the first particles 681 and the second particles 682 are Si/C particles, desired average particle diameter D1 and average particle diameter D2 can be achieved for the first particles 681 and the second particles 682, for example, by appropriately regulating a size of the SiO—C composite as a raw material. An amount of silicon (Si) contained in the first particles 681 and the second particles 682 can be regulated by appropriately regulating an amount of SiO in the SiO—C composite as a raw material.

In a form illustrated in FIG. 3, the negative electrode active material layer 64 further includes graphite particles 683. In addition to the first particles 681 and the second particles 682, the graphite particles 683 can function as a negative electrode active material. The graphite particles 683 expand and contract due to charging and discharging of the electricity storage device 100 to a smaller extent as compared to the first particles 681 and the second particles 682 that include silicon. Therefore, when the negative electrode active material layer 64 includes the graphite particles 683, the graphite particles 683 can play part of a role of the negative electrode active material in the negative electrode active material layer 64. Thus, expansion and contraction of the negative electrode sheet 60 due to charging and discharging of the electricity storage device 100 can be suppressed better.

The graphite particles 683 may be, for example, artificial graphite, natural graphite, or the like. The graphite particles 683 may include an amorphous carbon coating layer on a surface thereof. The graphite particles 683 may have, for example, an approximately spherical shape, but not particularly limited to. In this specification, with regard to the graphite particles 683, the “approximately spherical shape” means that an average aspect ratio of the graphite particles 683 based on an electron microscope (SEM) observation is 1 to 2 (preferably 1 to 1.5). Note that the average aspect ratio is obtained, for example, by acquiring a planar SEM observation image of the graphite particles 683, selecting multiple graphite particles 683 (for example, 10 to 100 graphite particles 683) from the SEM observation image at random to calculate an aspect ratio of each of the selected graphite particles 683, and calculating an arithmetic average value thereof. For example, an average particle diameter of the graphite particles 683 may be 5 μm to 30 μm, and may be 10 μm to 20 μm.

In a case where the negative electrode active material includes the graphite particles 683, from a viewpoint of achieving the effect described above, when it is assumed that a total of the first particles 681, the second particles 682, and the graphite particles 683 is 100 mass %, a ratio of the graphite particles 683 may be generally 20 mass % to 80 mass % (preferably 40 mass % to 75 mass %, and more preferably 50 mass % to 70 mass %).

The negative electrode active material layer 64 may include, in addition to the negative electrode active material, a conductive material. As the conductive material, for example, a carbon nanotube, such as a single-layer carbon nanotube (SWCNT), a double-layer carbon nanotube (DWCNT), a multilayer carbon nanotube (MWCNT), or the like, carbon black, such as acetylene black (AB) or the like, carbon fiber, or the like may be used. In particular, a carbon nanotube is preferable, and a single-layer carbon nanotube is more preferable. When a carbon nanotube is used as the conductive material, a conduction path is more preferably maintained, and a cycle characteristic of the electricity storage device 100 can be further increased.

A ratio of the negative electrode active material when it is assumed that the entire negative electrode active material layer 64 is 100 mass % is, for example, preferably 80 mass % or more, is more preferably 90 mass % to 99 mass %, and may be 95 mass % to 99 mass %. A ratio of the conductive material when it is assumed that the entire negative electrode active material layer 64 is 100 mass % may be, for example, 0.01 mass % to 1 mass %.

The negative electrode active material layer 64 may include, in addition to the negative electrode active material, a binder. Examples of the binder include, for example, carboxymethyl cellulose (CMC), polyacrylic acid (PAA), styrene-butadiene rubber (SBR), polyvinylidene fluoride (PVDF), or the like. In particular, carboxymethyl cellulose (CMC), polyacrylic acid (PAA), and styrene-butadiene rubber (SBR) can be preferably used. A ratio of the binder when it is assumed that the entire negative electrode active material layer 64 is 100 mass % may be, for example, 1 mass % to 10 mass %.

In manufacturing of the negative electrode sheet 60, the negative electrode active material and a material (the conductive material, the binder, or the like) used as necessary are dispersed in a proper solvent (for example, water) to prepare a pasty (or slurry) compound. Subsequently, the compound is applied to a surface of the negative electrode current collecting foil 62 and dried. Thereafter, the negative electrode sheet 60 in which the negative electrode active material layer 64 is provided on the surface of the negative electrode current collecting foil 62 is formed by performing pressing as necessary.

Examples of the separator 70 include, for example, a porous sheet (film) formed of a resin material, such as polyethylene (PE), polypropylene (PP), polyester, cellulose, polyamide, or the like. The porous sheet may have a single-layer structure, and may have a stacked structure including two or more layers (for example, a three-layer structure in which a PP layer is stacked on both surfaces of a PE layer). A heat resistance layer (HRL) may be provided on a surface of the separator 70.

The case 30 is, for example, an exterior container that houses the electrode body 20 and the nonaqueous electrolyte solution 80. The case 30 is herein a flat rectangular case. As illustrated in FIG. 1, the case 30 includes a positive electrode terminal 42, a negative electrode terminal 44, a safety valve 36, and a liquid injection hole (not illustrated). The positive electrode terminal 42 is, for example, an external connection terminal at a positive electrode side. The positive electrode terminal 42 is herein electrically connected to the positive electrode sheet 50 of the electrode body 20 via the current collecting plate 42a. The negative electrode terminal 44 is, for example, an external connection terminal at a negative electrode side. The negative electrode terminal 44 is herein electrically connected to the negative electrode sheet 60 of the electrode body 20 via the current collecting plate 44a. The safety valve 36 is a thin portion configured to, for example, when an internal pressure of the case 30 increases to a level equal to or higher than a predetermined level, release the internal pressure. The liquid injection hole is, for example, a portion through which the nonaqueous electrolyte solution 80 is injected to the case 30.

The nonaqueous electrolyte solution 80 includes, for example, an electrolyte salt, a nonaqueous solvent, and a capturing agent. Examples of the electrolyte salt include, for example, LiPF₆. A concentration of the electrolyte salt in the nonaqueous electrolyte solution 80 may be, for example, 0.7 mol/L to 1.3 mol/L. The nonaqueous solvent may be carbonates, such as, for example, ethylene carbonate (EC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), trifluorodimethyl carbonate (TFDMC), or the like. One of the carbonates described above can be individually used or two or more thereof can be combined and used.

The electricity storage device 100 can be used for various applications. Examples of preferable application include a drive power source mounted on a vehicle, such as a battery electric vehicle (BEV), a hybrid electric vehicle (HEV), a plug-in hybrid electric vehicle (PHEV), or the like. The electricity storage device 100 can be used as a storage battery, such as a small-sized power storage device or the like. The electricity storage devices 100 may be connected in series and/or in parallel to construct a battery pack.

As described above, the electricity storage device 100 includes the negative electrode active material layer 64 including the negative electrode active material 68. The negative electrode active material 68 includes the first particles 681 including silicon and the second particles 682 that include silicon and are different from the first particles 681. Herein, the average circularity CR1 of the first particles 681 is 0.5 or more and 0.9 or less. The average circularity CR2 of the second particles 682 is more than 0.9. The ratio (D2/D1) of the average particle diameter D1 of the first particles 681 and the average particle diameter D2 of the second particles 682 is 0.1 or more and less than 1.

In the electricity storage device 100 having the configuration described above, the negative electrode active material 68 that includes the first particles 681 including silicon and the second particles 682 including silicon is used, so that an increased capacity is achieved. The average particle diameter D1 of the first particles 681 having a relatively low average circularity is larger than the average particle diameter D2 of the second particles 682 having a relatively high average circularity. Therefore, the second particles 682 tend to enter voids generated between the first particles 681. Thus, increase of the specific surface area of the negative electrode active material layer 64 can be suppressed, and a more preferable specific surface area can be achieved. In addition of the effect of achieving a preferable specific surface area of the negative electrode active material layer 64, proper voids can be maintained in the negative electrode active material layer 64. Therefore, even when the negative electrode active material 68 expands and contracts due to charging and discharging of the electricity storage device 100, expansion and contraction of the negative electrode active material 68 are released by the voids. Thus, increase of the internal stress of the negative electrode active material layer 64 and disconnection of the conduction path can be suppressed.

Test examples related to the present disclosure will be described below, but it is not intended to limit the present disclosure to the test examples described below.

### Manufacturing of Test Cells

### First Example

In manufacturing of a negative electrode sheet, first, materials were prepared. As negative electrode active materials, first particles, second particles, and graphite particles were prepared. The first particles were Si/C particles having an average circularity of 0.64 and an average particle diameter of 10 μm. The second particles were Si/C particles having an average circularity of 0.95 and an average particle diameter of 2 μm. The graphite particles were graphite particles having an average particle diameter of 15 μm. As a conductive material, a single-layer carbon nanotube (SWCNT) was prepared. As binders, carboxymethyl cellulose (CMC), polyacrylic acid (PAA), and styrene-butadiene rubber (SBR) were prepared. The materials described above were mixed and kneaded with water as a solvent such that a mass ratio of thefirstparticles:thesecondparticles:thegraphiteparticles:SWCNT:CMC:PAA:SBR=31.5:3.5:65:0.1:1:1:1.5 is achieved, and thus a negative electrode mixture paste was formed.

In forming of the negative electrode mixture paste, first, the first particles, the second particles, pasty SWCNT (a solid content ratio 2%), and a dispersion medium were put into a kneading machine and were dispersed and mixed at 3000 rpm using a disperser to form a first paste. Next, using a stirring granulator, the graphite particles, CMC, and PAA were dry mixed. The first paste, mixed powder obtained by dry mixing, and the dispersion medium (water) were firmly kneaded and mixed. The solid content ratio during firmly kneading and mixing was 65%. SBR and the dispersion medium (water) were further added to a mixture obtained by firmly kneading and mixing and were mixed with the mixture. In the manner described above, the negative electrode mixture paste was formed. The negative electrode mixture paste was applied to both surfaces of copper foil having a thickness of 10 μm into a band-like shape. Then, the paste on the copper foil was dried and pressed to a predetermined thickness, and thereafter, was processed into predetermined dimensions to form the negative electrode sheet.

Next, lithium nickel cobalt manganese composite oxide (NCM) as a positive electrode active material, acetylene black (AB) as a conductive material, and polyvinylidene fluoride (PVDF) as a binder were prepared. The prepared materials were mixed to N-methyl pyrrolidone as a solvent such that a mass ratio of NCM:AB:PVDF=100:1:1 was achieved to form a positive electrode mixture paste. The paste was applied to both surfaces of aluminum foil having a thickness of 15 μm into a bank-like shape. Then, the paste on the aluminum foil was dried and pressed to a predetermined thickness, and thereafter, was processed into predetermined dimensions to form the positive electrode sheet.

A current collecting lead was attached to each of the positive electrode sheet and the negative electrode sheet obtained in the manner described above, the positive electrode sheet and the negative electrode sheet were stacked with a separator interposed therebetween, and thus, a stacked electrode body was formed. Subsequently, the stacked electrode body was inserted in an exterior body formed of an aluminum lamination sheet, a nonaqueous electrolyte solution was injected into the exterior body, and an opening of the exterior body was sealed to form a test cell of a first example. Note that, as the separator, a porous polyolefin sheet having a three-layer structure of PP/PE/PP was used. As the nonaqueous electrolyte solution, a nonaqueous electrolyte solution obtained by dissolving LiPF₆ as a support salt into a mixed solvent obtained by mixing ethylene carbonate (EC), fluoroethylene carbonate (FEC), ethyl methyl carbonate (EMC), and dimethyl carbonate (DMC) such that a volume ratio of EC:FEC:EMC:DMC=15:5:40:40 was achieved at a concentration of 1 mol/L was used.

Note that the average circularity CR1 of the first particles and the average circularity CR2 of the second particles were calculated by performing an image analysis on a particle image of each of the first particles and the second particles. In this image analysis, 3000 particles were used as samples for measurement. At this time, a circularity of each particle was calculated from a circumference (L) of each of the particles and a circumference (L0) of a circle having a same projection area as that of the particle using Expression A below.

$$Circularity = L 0 / L \qquad Expression A$$

A total of the circularities of the 3000 particles as samples was divided by a number of the particles (in this case, 3000) to calculate the average circularity CR1 and the average circularity CR2. Note that, in this test example, using an image type particle size distribution measuring device, the average circularity CR1 and the average circularity CR2 were measured.

### Second Example

For the negative electrode active material, the first particles, the second particles, and the graphite particles were prepared at a mass ratio of the first particles:thesecondparticles:thegraphiteparticles=26.25:87:25:65. Other than this, using similar materials and processes as those of the first example, a test cell of this example was formed.

### Third Example

As the second particles, the second particles whose average particle diameter D2 was 4 μm was used. Other than this, using similar materials and processes as those of the first example, a test cell of this example was formed.

### Fourth Example

As the second particles, the second particles whose average particle diameter D2 was 6 μm was used. Other than this, using similar materials and processes as those of the first example, a test cell of this example was formed.

### Fifth Example

For the negative electrode active material, the first particles, the second particles, and the graphite particles were prepared at a mass ratio of the first particles:thesecondparticles:thegraphiteparticles=21:14:65. Other than this, using similar materials and processes as those of the first example, a test cell of this example was formed.

### First Comparative Example

As the second particles, the second particles whose average particle diameter D2 was 0.7 μm was used. Other than this, using similar materials and processes as those of the first example, a test cell of this example was formed.

### Second Comparative Example

For the negative electrode active material, the first particles, the second particles, and the graphite particles were prepared at a mass ratio of the first particles:thesecondparticles:thegraphiteparticles=35:0:65. Other than this, using similar materials and processes as those of the first example, a test cell of this example was formed.

### Third Comparative Example

For the negative electrode active material, the first particles, the second particles, and the graphite particles were prepared at a mass ratio of the first particles:thesecondparticles:thegraphiteparticles=0:35:65. Other than this, using similar materials and processes as those of the first example, a test cell of this example was formed.

### <Evaluation of Specific Surface Area Increase Rate>

For each of the test cells of the examples, in the manufacturing process described above, the specific surface areas in the negative electrode sheet before and after pressing were calculated to obtain a specific surface area increase rate. In this case, for samples obtained by cutting each of the negative electrode sheets before and after pressing into predetermined dimensions, a gas absorption amount was measured by a gas absorption method using a commercially available specific surface area/fine pore distribution measuring device. As the absorption gas, nitrogen was used. As the specific surface area, a value obtained by a BET method was used. Then, the specific surface area increase rate (%) was calculated using Expression B below.

$$Specific surface area increase rate ( \% ) = [ \{ ( Specific surface area after pressing ) - ( Specific surface area before pressing ) \} / \\ ( Specific surface area before pressing ) ] \times 100 \qquad Expression B$$

Results are indicated in a corresponding column of Table 1.

### <Evaluation of Capacity Retention Rate>

For each of the test cells of the examples, a cycle test in which, in a 25° C. environment, with charging and discharging in which, after CCCV charging (rate 0.4° C. up to 4.2 V, and then, 0.1 C cut) was performed, CC charging (2.5 V cut at a rate of 0.4 C) was performed as one cycle, charging and discharging under the conditions described above were repeated until 200 cycles were reached was performed. Then, a discharge capacity (initial capacity) of a first cycle and a discharge capacity of a 200th cycle were measured, and the capacity retention rate (%) of each of the test cells of the examples was measured based on Expression C below.

$$Capacity retention rate ( \% ) = ( Discharge capacity of the {200}^{th} cycle / Initial capacity ) \times 100 \qquad Expression C$$

Results are indicated in a corresponding column of Table 1.

TABLE 1
Table 1

| | First Particles | | Second Particles | | | | Specific | |
|---|---|---|---|---|---|---|---|---|
| | | Average | | Average | | | Surface | |
| | | Particle | | Particle | Particle | | Area | Capacity |
| | Average | Diameter | Average | Diameter | Diameter | Mass | Increase | Retention |
| | Circularity | D1 | Circulaity | D2 | Ratio | Ratio | Rate | Rate |
| | CR1 | (μm) | CR2 | (μm) | (D2/D1) | (C2/C1) | (%) | (%) |
| First | 0.78 | 10 | 0.95 | 2 | 0.2 | 0.1 | 10 | 87 |
| Example | | | | | | | | |
| Second | 0.76 | 10 | 0.94 | 2 | 0.2 | 0.3 | 13 | 84 |
| Example | | | | | | | | |
| Third | 0.78 | 10 | 0.93 | 4 | 0.4 | 0.1 | 15 | 83 |
| Example | | | | | | | | |
| Fourth | 0.77 | 10 | 0.96 | 6 | 0.6 | 0.1 | 19 | 75 |
| Example | | | | | | | | |
| Fifth | 0.75 | 10 | 0.94 | 2 | 0.2 | 0.7 | 17 | 72 |
| Example | | | | | | | | |
| First | 0.78 | 10 | 0.95 | 0.7 | 0.07 | 0.1 | 24 | 78 |
| Comparative | | | | | | | | |
| Example | | | | | | | | |
| Second | 0.76 | 10 | — | — | — | — | 28 | 81 |
| Comparative | | | | | | | | |
| Example | | | | | | | | |
| Third | — | — | 0.96 | 2 | — | — | 20 | 74 |
| Comparative | | | | | | | | |
| Example | | | | | | | | |

As indicated in Table 1, each of the test cells of the first to fifth examples includes, as negative electrode active materials, the first particles and the second particles that include silicon. In each of the test cells of the first to fifth examples, the average circularity CR1 of the first particles was 0.5 or more and 0.9 or less, the average circularity CR2 of the second particles was more than 0.9, and the ratio (D2/D1) between the average particle diameter D1 of the first particles and the average particle diameter D2 of the second particles was 0.1 or more and less than 1. It was found that, in each of the negative electrode sheets used for the test cells of the first to fifth examples, the specific surface area increase rate before and after pressing was lower than those of the comparative examples. It was understood that the negative electrode sheets used for the test cells of the first to fifth examples were less likely to be affected by pressing than the negative electrode sheets of the first to third comparative examples and a more preferable specific surface area was achieved in each of the negative electrode sheets used for the test cells of the first to fifth examples.

As described above, the following items are given as specific aspects of the technology disclosed herein.

First Item: An electricity storage device that includes a negative electrode active material layer including a negative electrode active material, the negative electrode active material including first particles including silicon and second particles that include silicon and are different from the first particles, and in which an average circularity of the first particles is 0.5 or more and 0.9 or less, an average circularity of the second particles is more than 0.9, and a ratio between an average particle diameter of the first particles and an average particle diameter of the second particles is 0.1 or more and less than 1.
Second Item: The electricity storage device according to the first item, in which a ratio between a content of the first particles and a content of the second particles in the negative electrode active material is 0.5 or less.
Third Item: The electricity storage device according to the first or second item, in which the ratio between the average particle diameter of the first particles and the average particle diameter of the second particles is 0.5 or less.
Fourth Item: The electricity storage device according to any one of the first to third items, in which the average particle diameter of the second particles is 1 μm or more and 5 μm or less.
Fifth Item: The electricity storage device according to any one of the first to fourth items, in which the first particles and the second particles both are composite particles of silicon and carbon.
Sixth Item: The electricity storage device according to any one of the first to fifth items, in which the negative electrode active material layer further includes graphite particles.

A preferred embodiment of the present disclosure has been described above, but it is not intended to limit the technology disclosed herein to the preferred embodiment described above. The technology disclosed herein can be implemented in various other embodiments. The technology described in the scope of claims includes various modifications and changes of the preferred embodiments described as examples above. For example, a portion of the preferred embodiment described above can be replaced with some other modified aspect. Some other modified aspect can be added to the preferred embodiment described above. Additionally, a technical feature can be deleted as appropriate unless the technical feature is described as an essential element.

What is claimed is:

1. An electricity storage device comprising:
a negative electrode active material layer including a negative electrode active material,
the negative electrode active material including
first particles including silicon, and
second particles that include silicon and are different from the first particles, wherein
an average circularity CR1 of the first particles is 0.5 or more and 0.9 or less,
an average circularity CR2 of the second particles is more than 0.9, and
a ratio (D2/D1) between an average particle diameter D1 of the first particles and an average particle diameter D2 of the second particles is 0.1 or more and less than 1.

2. The electricity storage device according to claim 1, wherein
a ratio (C2/C1) between a content C1 of the first particles and a content C2 of the second particles in the negative electrode active material is 0.5 or less.

3. The electricity storage device according to claim 2, wherein
the ratio (D2/D1) between the average particle diameter D1 of the first particles and the average particle diameter D2 of the second particles is 0.5 or less.

4. The electricity storage device according to claim 1, wherein
the average particle diameter D2 of the second particles is 1 μm or more and 5 μm or less.

5. The electricity storage device according to claim 1, wherein
the first particles and the second particles both are composite particles of silicon and carbon.

6. The electricity storage device according to claim 1, wherein
the negative electrode active material layer further includes graphite particles.
